(19) United States
(12) Patent Application Publication
(10) Pub. No.: US 2026/0213421 A1
(43) Pub. Date: Jul. 23, 2026

(54) METASURFACE WITH INTEGRATED GRAPHENE DEVICES FOR AMPLITUDE CONTROL

(71) Applicant: Dell Products L.P., Round Rock, TX (US)

(72) Inventors: Tejinder Singh, San Jose, CA (US); Navjot Kaur Khaira, San Jose, CA (US); Jesse Stewart, Ottawa (CA); David F. Hardy, Ottawa (CA); Shulabh Gupta, Ottawa (CA)

(21) Appl. No.: 19/277,350

(22) Filed: Jul. 22, 2025

Related U.S. Application Data
(60) Provisional application No. 63/747,210, filed on Jan. 20, 2025.

(51) Int. Cl. H01Q 15/00

(52) U.S. Cl. CPC H01Q 15/002; H01Q 15/0086

(57) ABSTRACT

The technology described herein is generally directed towards an electronically tunable unit cell integrated with graphene for amplitude and phase control, such as for use in a metasurface to controllably redirect beamformed signals in the millimeter wave (mm-wave) band and higher. By controllably varying the variable resistance of the graphene material in patches coupled to metallic parts of a metallic ring resonator, controlled reflection response variation can be achieved to beamform redirected instances of incoming signals. In one implementation, the metasurface can be highly optically transparent, based on the small dimensions of the unit cells' resonating elements that include the graphene material, an optically transparent substrate, and a substantially optically transparent mesh ground plane, whereby, for example, the metasurface can be integrated in glass panels. Evaluation results indicate suitability of the metasurface in mm-wave communications. The graphene materials can be monolithically integrated into metasurface unit cells using microfabrication clean-room processes.

### RELATED APPLICATION

The subject patent application claims priority to U.S. Provisional Patent Application Ser. No. 63/747,210, filed Jan. 20, 2025, and entitled “METASURFACE WITH INTEGRATED GRAPHENE DEVICES FOR AMPLITUDE CONTROL” (docket no. 142236.01/DELLP1497US), the entirety of which patent application is hereby incorporated by reference herein.

### BACKGROUND

Signals in the millimeter wave (mm-wave, e.g., Ka, V, and W) frequency bands and higher experience high attenuation (significant blockage) through materials commonly found in cities or indoor environments. Such attenuation poses a challenge in deploying reliable and high throughput mm-wave communication networks.

Technologies generally known as metasurfaces (or reflectarrays or reconfigurable intelligent surfaces) can be developed to mitigate blockage issues by redirecting signals around obstacles, thus maintaining a virtual line of sight between a signal source and signal receiver. In general, a metasurface is composed of unit cells, which are two-dimensional arrays of sub-wavelength scattering elements often integrated with actively biased components. The actively biased components facilitate dynamic control to manipulate the response of electromagnetic (EM) radiation. By controlling the unit cells via biasing, a metasurface can focus, block, or steer the main lobe of the scattered EM field towards the target by controlling the reflectance or transmittance magnitude and phase.

### BRIEF DESCRIPTION OF THE DRAWINGS

FIG. 1 is a top-view representation of an example metasurface (unit cell array) based on resonators including graphene patches, in accordance with various example embodiments and implementations of the subject disclosure.

FIG. 2 is a top view, zoomed-in representation of an example unit cell of FIG. 1, including a resonator with metallic parts and graphene patches above a mesh ground plane, in accordance with various example embodiments and implementations of the subject disclosure.

FIG. 3 is a three-dimensional isometric view of an example optically transparent unit cell configuration including a hexagonally-shaped resonating element with metallic parts and graphene patches on a substrate above a mesh ground plane, in accordance with various example embodiments and implementations of the subject disclosure.

FIG. 4 is a top view representation of an example unit cell along with graphene patches showing unit cell size dimensions, in accordance with various example embodiments and implementations of the subject disclosure.

FIG. 5 is a top view representation of an example metallic ground plane portion with openings arranged in a uniform honeycomb-like pattern, in accordance with various example embodiments and implementations of the subject disclosure.

FIGS. 6 and 7 are graphical representations of simulated reflection amplitude tuning range (FIG. 6) for an example unit cell with graphene sheet resistances in a first regime (from 10 ohms per square (Ω/sq) to 150 Ω/sq), and the associated phase variation (FIG. 7), respectively, in accordance with various example embodiments and implementations of the subject disclosure.

FIG. 8 is a graphical representation of simulated reflection amplitude tuning range for an example unit cell graphene with sheet resistances in a second regime (from 200 Ω/sq to 3000 Ω/sq), in accordance with various example embodiments and implementations of the subject disclosure.

FIG. 9 is a graphical representation of simulated reflection phase variation for an example unit cell graphene with graphene sheet resistances in the second regime (from 200 Ω/sq to 3000 Ω/sq), in accordance with various example embodiments and implementations of the subject disclosure.

### DETAILED DESCRIPTION

The technology described herein is generally directed towards a reflector metasurface unit cell employing integrated graphene devices for amplitude control, as well as for associated phase control. Graphene has a variable conductivity, which can be altered by the application of an external electric field, in this case in the form of a voltage bias. This property allows graphene to be deployed as a reconfigurable material in wireless systems. In one implementation, the ring resonator includes first and second parts of the metallic split ring separated by gaps, with the ring resonator completed by a pair of graphene patches coupled between the first and second parts.

In general, graphene is a monolayer of carbon atoms arranged in a hexagonal lattice. Graphene is a good conductor with a high carrier mobility and is well suited to high-frequency applications, and also functions as a zero-bandgap semiconductor. By altering the sheet resistance of the graphene patches via voltage control as described herein, the amplitude (and phase) of electromagnetic waves reflected by the metasurface unit cell can be tuned, that is, unit cell tunability can be achieved by selectively varying individual bias voltages applied to the individual graphene patches.

The unit cell can be implemented in a metasurface (reflectarray) with high optical transparency. In this implementation, the substantially optically transparent unit cell resonator including the hexagonal metallic split ring structure with graphene patch(es) can be designed atop an optically transparent fused-silica dielectric substrate, with the substrate above a substantially optically transparent perforated (meshed) metallic ground plane.

Note that in general, wireless communication systems in millimeter wave (mm-Wave) frequency bands and higher are capable of exceptionally high throughput and data-rates, but are hindered by high attenuation losses from objects common to indoor and outdoor urban environments that intervene in the signal path. To address this issue so as to make use of these frequency bands in next-generation wireless networks, described herein is a reflector metasurface capable of variable reflection amplitude is presented here, as a preliminary step towards reconfigurable beam-steering around obstructions common to urban environments. Metasurfaces (MTS) are two-dimensional structures that allow for precise control of electromagnetic waves by engineering the geometry of constituent unit cells, thereby facilitating the rerouting of beamformed instances of redirected mm-Wave signals around obstacles in the wireless environment.

Thus, as will be understood, the graphene patches as described herein can be used as a transparent reconfigurable material and combined with a perforated ground plane to create a highly optically transparent reflectarray of unit cells. In one or more implementations, graphene patches are integrated into a ring resonator structure to provide tunable reflection amplitude for a range of graphene sheet resistances from 10 Ω/sq to 3000 Ω/sq, in the frequency range from 25 GHz to 30 GHz. The integrated graphene patches also provide a tunable reflection phase at 26 GHz and 30 GHz. Each metasurface unit cell can include a transparent (e.g., fused silica) substrate, with a perforated metallic ground plane on one side, and an array of metallic hexagonal rings on the other. The metasurface in one implementation is designed to operate in the frequency range from 25 to 30 gigahertz (GHz). The size of each unit cell is designed to be smaller than the free-space wavelength of electromagnetic waves at the intended operating frequencies. The graphene patches have a variable sheet resistance which can be altered by the application of a bias voltage. By altering the sheet resistance, the amplitude of electromagnetic waves reflected by the metasurface can be controllably adjusted.

It should be understood that any of the examples herein are non-limiting. Thus, any of the embodiments, aspects, concepts, structures, functionalities or examples described herein are non-limiting, and the technology may be used in various ways that provide benefits and advantages in communications and metasurfaces in general.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. Similarly, “maximize” means moving towards a maximal state (e.g., up to some practical limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

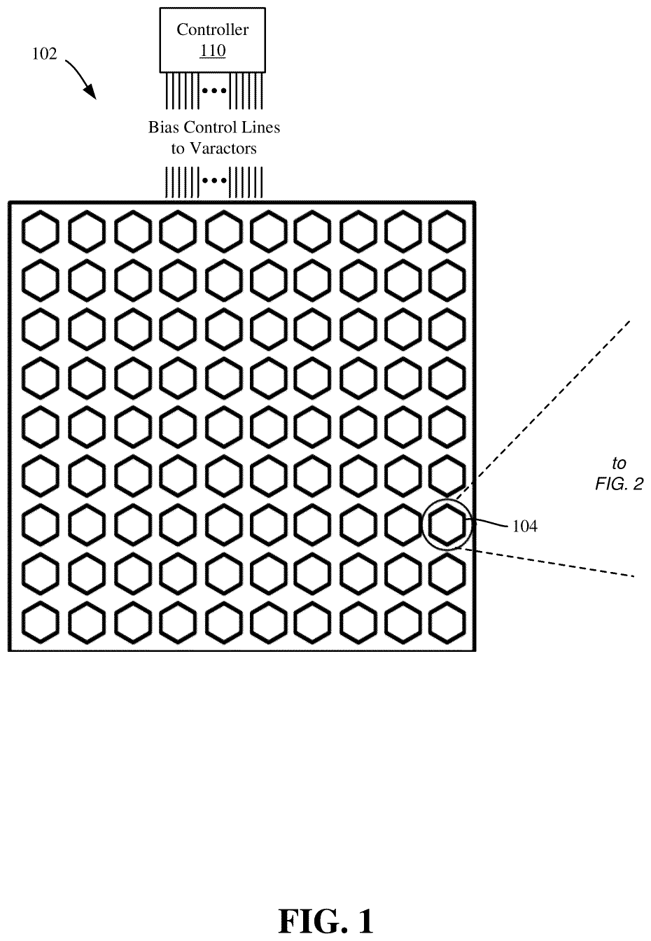

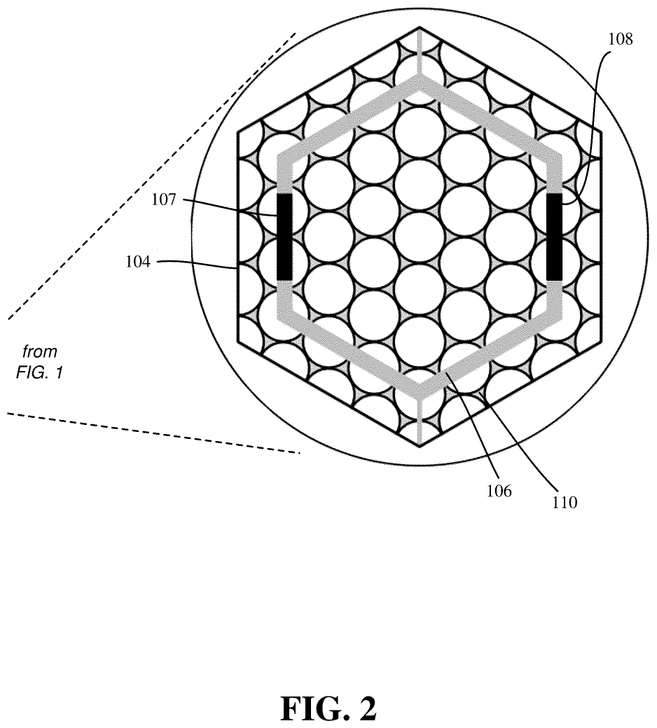

FIG. 1 shows a system 100 including an example of metasurface 102 (or reflectarray) using hexagonal ring unit cells with graphene-based amplitude and phase control as described herein. One of the example hexagonal ring unit cells is labeled 104 in FIG. 1, which is shown in a zoomed-in representation in FIG. 2.

FIG. 2 shows distinct components of the example unit cell 104, including a hexagonal ring resonator 220 that includes a metallic split ring set including metallic parts 222(1) and 222(2), separated by and coupled to a graphene patch set including two graphene patches 225 and 226. The split metallic parts 222(1) and 222(2) of the hexagonal ring resonator are thus separated by a pair of symmetrical gaps, with a pair of symmetrical graphene patches 225 and 226 placed in the gaps, thereby basically acting as tunable resistors that complete the ring resonator structure. Note that while a pair of graphene patches are depicted in FIG. 2, a single graphene patch can be used in a given unit cell design, or the metallic ring can be split into more than two parts with more than two graphene patches between the parts.

Graphene is a two-dimensional carbon allotrope that acts as a zero-bandgap semiconductor, exhibiting high carrier mobility resulting from ballistic carrier transport, and a variable sheet resistance that can be controlled by an externally applied electric field. The sheet resistance Rs of graphene can be varied from kiloohms to tens of ohms by the application of a DC bias voltage. These properties make it suitable for use as a reconfigurable material in metasurface design. Furthermore, graphene has a high optical transparency of 97.7%, allowing it to be used as a transparent device.

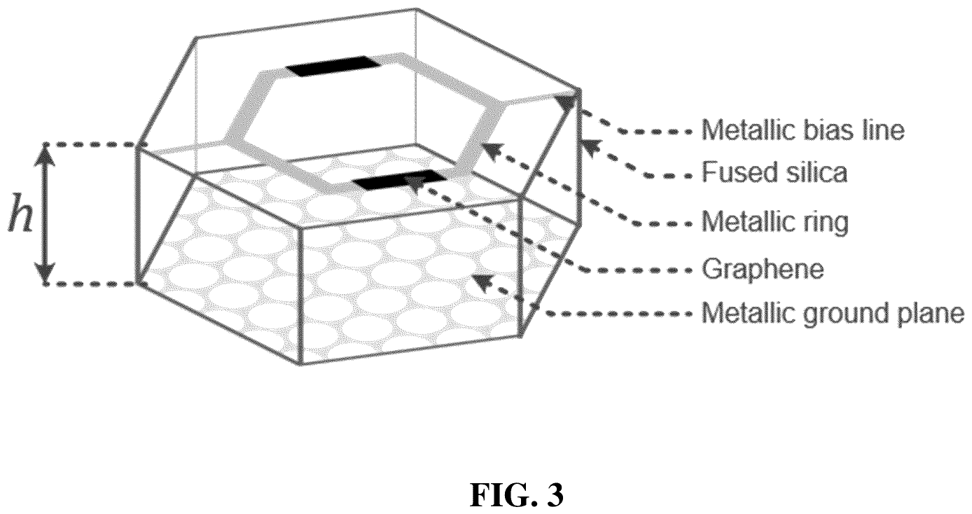

The unit cell is over a portion of a mesh ground plane 228 as described herein; in general, the mesh ground plane 228 is a metal structure (with openings/perforations/punctures) that extends beneath the entire metasurface 102 of FIG. 1, with a corresponding portion thereof beneath each unit cell. That is, the unit cells are backed by a metallic ground plane to enable a reflection operation; circular perforations are made in the ground plane to improve optical transparency, as illustrated in FIG. 3. The perforations are arranged in a hexagonal pattern to align with the hexagonal shape of the lattice used for the unit cell, and to ensure an optimal packing of perforations.

FIG. 3 shows an isometric view of the unit cell 102, with a substrate 330 between the resonator (the metallic ring parts 222(1) and 222(2), and the graphene patches 225 and 226), and the corresponding portion of the mesh ground plane 228. In one implementation, the substrate 330 is optically (or substantially optically) transparent, such as made of fused silica. Metallic bias lines 332(1) and 332(2), for applying voltage bias to the graphene patches to change their resistance, are also shown in FIG. 3. The metallic bias lines 332(1) and 332(2) can be the same conductive material (e.g., aluminum, copper or the like) as the metallic ring parts 222(1) and 222(2).

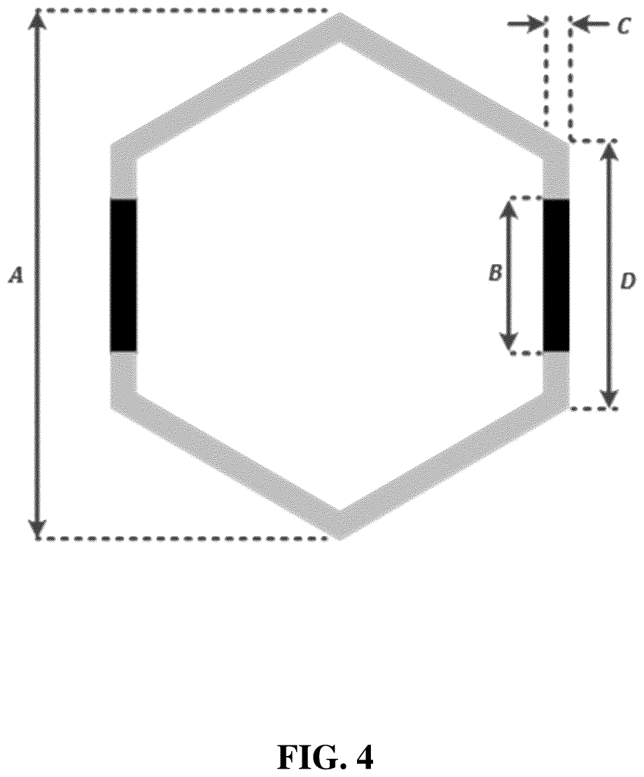

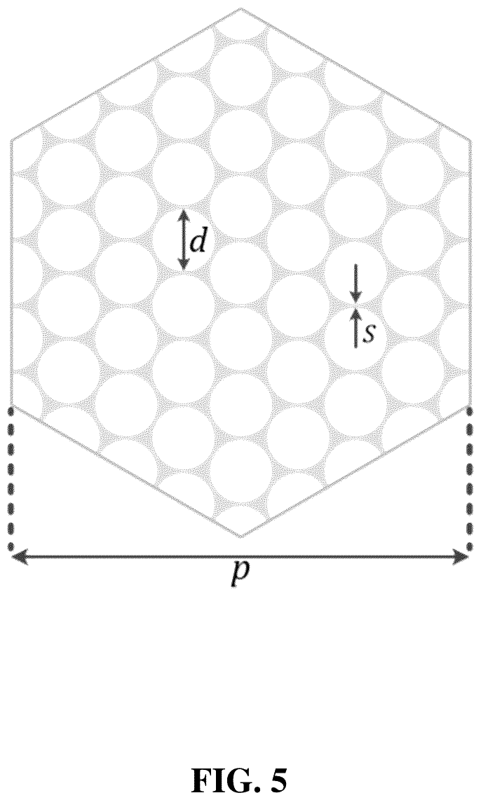

In one implementation, the example metasurface unit cell 104 has dimensions and properties including those of the fused silica substrate 330 (εᵣ=4.0, h=0.5 mm) shown in FIG. 3. Example dimensions for the hexagonal metallic ring parts 220(1) and 220(2), and the graphene patches 225 and 226 (modeled as sheet resistances in simulation) are shown in FIG. 4, and those for the perforated metallic ground plane 228 are shown in FIG. 5. As shown in FIG. 4 the overall hexagonal resonator height (and width) size A, the graphene patch length B, the resonator width c, and the hexagonal sides' length D are A=2 mm, B=0.75 mm, C=0.1 mm, D=1.0 (to 1.1) mm, respectively, in this example implementation. FIG. 5 shows the portion of the perforated ground plane 228 at the bottom of the reflectarray unit cell 104; in this example implementation the diameter d of the perforations in the honeycomb ground plane is d=0.19 mm, and the smallest spacing between adjacent perforations is S≈6.5 μm. The period for each honeycomb unit cell in the array of unit cells is p=2.68 mm.

Note that graphene is substantially optically transparent, and in any event the dimensions of the graphene patches 225 and 226, the metallic ring parts 220(1) and 220(2) (resonator), and the bias lines are relatively very small. The mesh ground plane 228 is substantially optically transparent due to its perforations. As such, in the example implementation, the combination of an optically transparent substrate 330 with the ring resonator, bias lines and mesh ground plane 228 result in a substantially optically transparent metasurface.

To summarize, described herein is a resonator unit cell capable of real-time tunable reflection amplitude through the variation of the sheet resistance of integrated graphene sheets, which can be designed with high optical transparency. This is achieved using a perforated ground plane and a suitable choice of an optically transparent base substrate, along with graphene as a transparent, variable resistance conductor. Using various unit cell simulations, the operation of the designed unit cell is confirmed, while describing the behavior of the unit cells for various sheet resistances ranges.

The example unit cell 104 is thus based on a metallic hexagonal ring resonator, and is developed in the mm-Wave band of 28 GHz for demonstration, with the example unit cell configuration illustrated in FIGS. 2-5 . A DC bias voltage applied across the graphene patches (using a biasing network, not explicitly shown, but corresponding to the bias control lines of the controller 110 in FIG. 1) alters the sheet resistance of the graphene patches, which can be used to alter the power reflected by the unit cell. Each unit cell of the metasurface array can be independently biased. The direct current/voltage bias can be applied through metallic bias lines connected to the two parts of the hexagonal ring using standard techniques to ensure minimum interaction with the impinging RF waves.

The scattering of radiation with polarization perpendicular to the graphene patches was evaluated. More particularly, for a numerical demonstration, the unit cell was simulated in FEM-HFSS using periodic boundary conditions to simulate an infinite periodic array. Floquet port excitation was used under normal incidence.

In a fabricated metasurface, applying a bias voltage to the graphene patches is through metallic bias lines coupled to the two split metallic parts of the hexagonal rings, as shown in FIG. 3 of the metasurface unit cell 104. In a reconfigurable metasurface, the voltage bias can be binary, allowing switching between the higher and lower reflection amplitude or reflection phase states. Such DC bias lines were not implemented in the simulation model, however these bias lines can be designed (e.g., as in FIG. 3) in fabricated implementations such that they are thin, sufficiently small and oriented to interfere minimally with the unit cell structure, for example as depicted in FIG. 3.

The unit cell with a perforated ground plane provides optical transparency. The bridge thickness S≈6.5 μm was chosen throughout the simulation models, giving the ground plane an optical transparency of about 87%. The bridge thickness was chosen based on acceptable transparency values while keeping a standard cleanroom-based microfabrication process in perspective. The graphene patches were modeled as sheet resistances in simulation using the example dimensions A=2 mm, B=0.75 mm, C=0.1 mm, D=1 mm as set forth herein. The graphene patches were modeled in simulation as finite sheet impedance boundaries, with a variable resistance and a constant zero reactance. The metallic ring and ground plane were modeled as finite conductivity sheets, with aluminum used as the conductivity model.

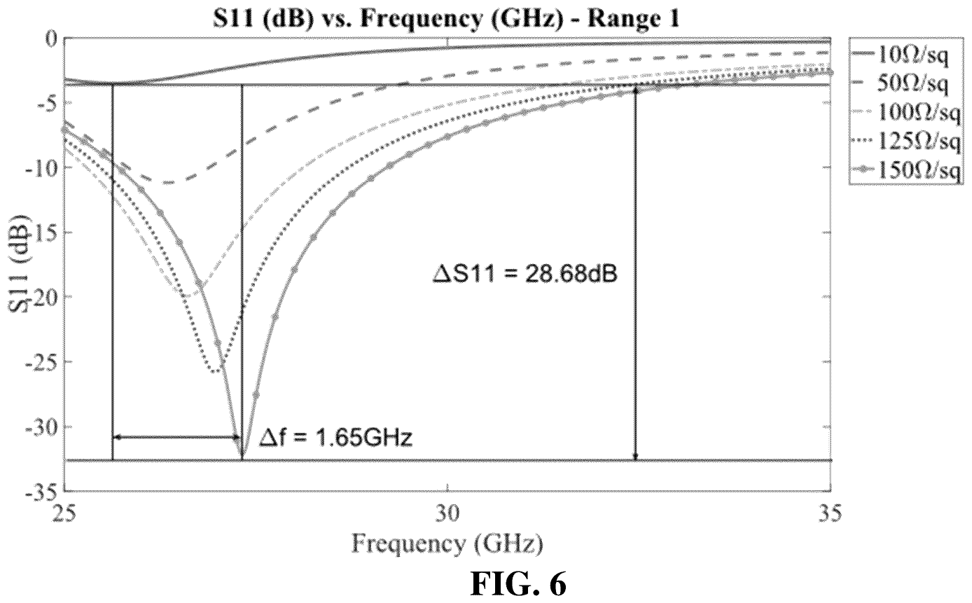

The designed metasurface was simulated using Ansys HFSS in a Floquet port simulation. The simulations were performed in the frequency range from 25 to 35 GHz to demonstrate the concept of reflection amplitude tunability. The Floquet port simulation excited two perpendicular wave modes. By adjusting the sheet resistance of the integrated graphene elements, the reflection amplitude of the mode perpendicular to the graphene patches can be altered, as shown in FIGS. 6-9 .

More particularly, the sheet resistance of the graphene patches was varied from 10 Ω/sq to 3000 Ω/sq, resulting in two regimes. Indeed, two distinct reflection amplitude tuning regimes were identified with different reflection tuning behavior. For instance, one regime for the designed unit cell corresponded to sheet resistance values from 10 ohms/square (Ω/sq) to 150 Ω/sq, and the other corresponding to sheet resistance values from 200 Ω/sq to 3000 Ω/sq. These two regimes have different reflection amplitude variations as sheet resistance is changed.

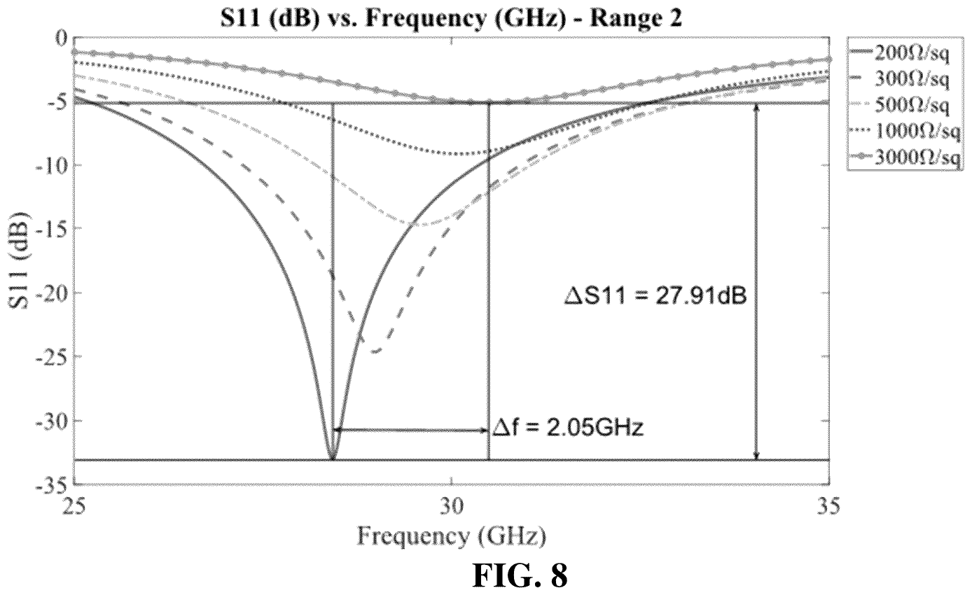

For example, as graphically shown in FIG. 6, in the first regime of the lower resistance values, the reflection amplitude (|Γ| or S₁₁, in dB) decreases with increasing sheet resistance, e.g., |Γ|∝1/Rₛ, while being |Γ|∝Rₛ in the second regime, as graphically shown in FIG. 8. The transition point where this behavior changes generally depends on the unit cell configuration, and thus can effectively be designed.

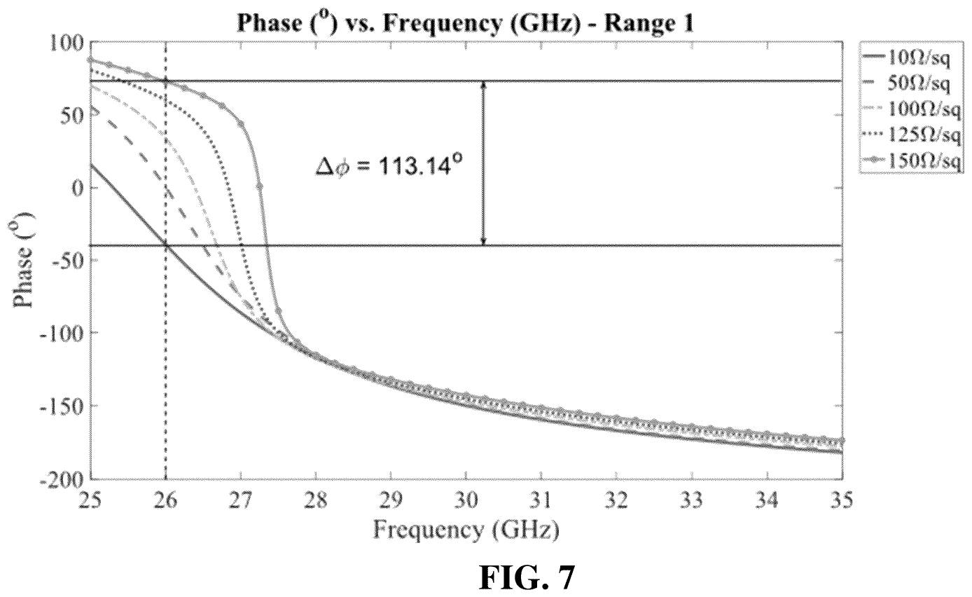

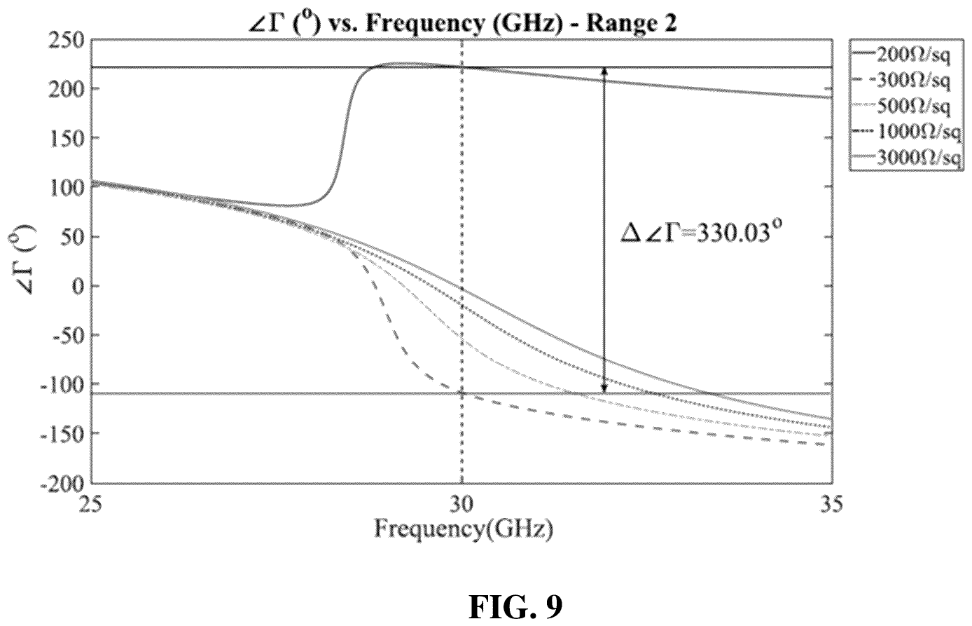

The reflection amplitude and the corresponding phase responses (phase in degrees, or ∠Γ(°)) in these two regimes are shown in FIGS. 6 and 7, respectively for the first regime, and in FIGS. 8 and 9 for the second regime, respectively. By varying the sheet resistance of the graphene patches from 10 Ω/sq to 150 Ω/sq, a reflection amplitude tuning range of 28.68 dB is achieved, accompanied by a shift in resonant frequency of 1.65 GHz. Varying the sheet resistance of the graphene patches also results in a change in reflection phase, as shown in FIG. 7. By varying the sheet resistance from 10 Ω/sq to 150 Ω/sq, the reflection phase changes by 113.14° at 26 GHz.

By varying the sheet resistance of graphene patches from 200 Ω/sq to 3000 Ω/sq, a reflection amplitude tuning range of 27.91 dB is achieved, accompanied by a shift in resonant frequency of 2.05 GHz, as shown in FIG. 8. Further, by varying the sheet resistance from 200 Ω/sq to 3000 Ω/sq, the reflection phase (from 300 Ω/sq to 3000 Ω/sq) changes by 105.47° at 30 GHz, as shown in FIG. 9. Note that at 200 Ω/sq sheet resistivity, the phase response deviates significantly, starting around 27 GHz, relative to the sheet resistances at or above 300 Ω/sq.

These results indicate a wide tuning range of reflection amplitude for a realistic range of graphene sheet resistances. They also show that two different reflection amplitude tuning modes can be achieved for different operating frequencies within the 25-30 GHz band. The results further show that reflection phase tuning is also achievable using the metasurface unit cell described herein; such phase tuning can be further optimized to obtain a wider tuning range.

For example, the aspect ratio of the rectangular graphene patches has an impact on the response of the unit cell, where the aspect ratio refers to the ratio of the width of the graphene patches to the length. The response results shown in FIG. 10 are not directed to an optimized response, as indeed, the reflection amplitude and phase tunability responses can be improved by further optimization of the aspect ratio of the graphene patches. The size of the ring, including the thickness and side length, can also be optimized to improve the response.

As can be seen, in both regimes a large variation of the reflection amplitude with sheet resistance is observed, demonstrating the feasibility of the unit cell design with good tunable performance. While the |Γ| versus Rs behavior is different in these two regimes, the effective amplitude control is comparable. Depending on the resistance of a practical graphene sheet (which is highly dependent on the fabrication process), the unit cell design can be tailored to operate in either of these regimes. It is further observed that changing sheet resistance also affects the resonant frequency of the unit cell, thereby affecting its phase, which it to be taken into account when designing surfaces with the non-uniform amplitude profile across them.

To summarize, described herein in one example implementation is an optically transparent metasurface reflector structure configured to obtain electronically tunable reflection amplitude and is demonstrated using full-wave simulations. The combination with graphene elements for increased transparency and variable reflectivity is described herein, in conjunction with the use of a perforated ground plane for increasing optical transparency along with a hexagonal ring element in a reflectarray design. Each unit cell is comprised of a metallic ring resonator integrated with graphene sheets on fused silica with a perforated metallic ground plane, which provides the intended optical transparency from both the substrate and the ground plane. The unit cell can be designed for operation in the mm-Wave frequency range, and shows a wide reflection amplitude range obtained through variation of the sheet resistance of the integrated graphene elements. As is understood, graphene as described herein can be employed in electronically reconfigurable beam-steering metasurfaces in mm-Wave applications for 5G wireless communications systems.

One or more implementations can be embodied in a unit cell device, such as described in the example embodiments and implementations included herein. The unit cell device can include a resonating element, including a split metallic ring set and an amplitude control device set coupled to a gap set in the split metallic ring. The amplitude control device set can include a graphene material patch set that changes resistance based on applied voltage. The unit cell device can include at least a portion of a ground plane beneath the metallic resonating element and the amplitude control device. The resistance of the graphene material patch set is controllably variable, when varied, to result in a corresponding reflection amplitude of the unit cell.

When resistance of the graphene material patch set is controllably varied, a corresponding phase response results in the unit cell being varied based on the resistance.

The unit cell device further can include an optically transparent, or substantially optically transparent, substrate between the metallic resonating element and the mesh ground plane.

The split metallic ring set and the amplitude control device set can include a hexagonal resonator.

The split metallic ring set can include a first metallic part and a second metallic part separated by a first gap and a second gap, respectively, of the gap set, the amplitude control device set can include a first graphene material patch that couples the first metallic part to the second metallic part at the first gap, and the amplitude control device set can include a second graphene material patch that couples the first metallic part to the second metallic part at the second gap.

The split metallic ring set and the amplitude control device set can include a hexagonal resonator, the first gap and the first graphene material patch can be on a first side of the hexagonal resonator, and the second gap and the second graphene material patch can be on a second side of the hexagonal resonator that can be different from the first side.

The first side can be opposite the second side.

The substrate can be an optically transparent, or substantially optically transparent, substrate, the ground plane can be a substantially optically transparent mesh ground plane, and the split metallic ring set, the graphene material patch set, and at least the portion of the mesh ground plane form a substantially optically transparent unit cell.

The substantially optically transparent unit cell can be part of a honeycomb lattice of unit cell devices.

The substantially optically transparent unit cell can be part of a metasurface of unit cells.

The resistance of the graphene material can include a sheet resistance, and the resistance of the graphene material patch set can be controllably varied by controllably varying controllably variable resistance values. In a first regime, the controllably variable resistance values of the graphene material can correspond to a decrease in reflection amplitude as the sheet resistance increases, and, in a second regime, the controllably variable resistance values of the graphene material can correspond to an increase in reflection amplitude as the sheet resistance increases; the sheet resistance, in the first regime, can include a first range of low sheet resistance values lower than, and relative to, a second range of high sheet resistance values in the second regime.

The unit cell can be a first unit cell of respective unit cells configured as a metasurface, the respective unit cells can have respective controllably variable reflection amplitudes and respective controllably variable phase responses, and the respective variable reflection amplitudes and the respective variable phase responses can be controlled to result in an amplitude and phase profile of the metasurface that redirects a signal impinging on the metasurface as a redirected beamformed instance of the signal.

One or more implementations can be embodied in a metasurface, such as described in the example embodiments and implementations included herein. The metasurface can include a substrate, and respective unit cells above the substrate; the respective unit cells can include respective resonators having respective variable reflection amplitudes, and the respective resonators can include respective metal ring sets and respective voltage-controllable graphene material patch sets. The metasurface can include a mesh ground plane beneath the substrate, and the mesh ground plane can include openings that can be optically transparent or substantially optically transparent. The metasurface can be a substantially optically transparent metasurface based on the substrate being transparent or substantially optically transparent, the mesh ground plane being transparent or substantially optically transparent, and respective dimensions of the respective resonators.

The respective voltage-controlled graphene material patch sets can be independently controlled to determine an amplitude and phase profile that redirects a signal impinging on the metasurface as a redirected beamformed instance of the signal.

The respective voltage-controlled graphene material patch sets can be independently controlled in a first operation to determine a first amplitude and phase profile, the signal impinging on the metasurface can be a first signal, the redirected beamformed instance can be a first redirected beamformed instance, the first redirected beamformed instance of the signal can have a first amplitude value and a first direction, the respective voltage-controlled graphene material patch sets can be independently controlled in a second operation to determine a second amplitude and phase profile that redirects a second signal impinging on the metasurface as a second redirected beamformed instance of the signal, and the second redirected beamformed instance of the signal can have a second amplitude value and a second direction that can be different from the first amplitude value and the first direction.

The respective unit cells can be arranged in a honeycomb lattice configuration.

The respective resonators can include substantially optically transparent respective metal ring sets and respective voltage-controllable graphene material patch sets, the substrate can be an optically transparent, or substantially optically transparent, substrate, the ground plane can be a substantially optically transparent mesh ground plane, and the respective resonators, the optically transparent, or substantially optically transparent, substrate, and the substantially optically transparent mesh ground plane sets can form the metasurface as a substantially optically transparent metasurface.

One or more implementations can be embodied in a unit cell, such as described in the example embodiments and implementations included herein. The unit cell can include a resonating element, the resonating element including a ring resonator. The ring resonator can include at least two metallic parts divided by, and coupled to, at least one graphene patch set having variable resistance. The unit cell can include an optically transparent, or substantially optically transparent, substrate beneath the resonating element, and a metal mesh structure corresponding to a ground plane beneath the optically transparent, or substantially optically transparent, substrate. The metal mesh structure can include optically transparent opening; in response to an electromagnetic wave impinging on the unit cell at a frequency that resonates the resonating element, the unit cell can redirect an instance of the electromagnetic wave based on a reflection amplitude and phase response determined by the variable resistance of the at least one graphene patch set.

The at least two metallic parts, in conjunction with the at least one graphene patch set can be hexagonally-shaped ring resonator.

The at least two metallic parts can include a first metallic part and a second metallic part separated by a first gap and a second gap, respectively. The at least one graphene patch set can include a first graphene material patch that couples the first metallic part to the second metallic part at the first gap, and the at least one graphene patch set can include a second graphene material patch that couples the first part to the second part at the second gap.

As can be seen, described herein is a metasurface unit cell integrated with graphene devices capable of achieving electronically tunable reflection amplitude. By varying the sheet resistance of integrated graphene patches, two distinct reflection amplitude tuning regimes were identified where either the amplitude response was inversely proportional to the sheet resistance (|Γ|∝1/Rₛ), or proportional to the sheet resistance |Γ|∝Rₛ, respectively.

Further, in one implementation, the presence of the perforated ground plane, the choice of a transparent fused silica substrate, and the use of graphene as a transparent reconfigurable conductor together provide high optical transparency. The high transparency of the unit cell design implementation allows for the design of low profile metasurface reflectors that can be used in spaces where aesthetics are important, and can be built into LCD screens, windows, or other transparent objects common to a particular wireless environment.

Evaluation results confirm graphene's suitability for use in metasurfaces (reflectarrays) in mm-Wave applications in 5G wireless systems, with wide reflection amplitude and phase tuning ranges achievable using relatively straightforward graphene geometries and achievable sheet resistances. Voltage biasing of the graphene patches can be achieved via bias lines in the unit cell structure.

Usage examples include smart windows; optically transparent reflective metasurfaces can be integrated into glass panels to redirect mm-wave signals around obstacles like furniture or columns, ensuring consistent high-speed wireless connectivity in offices. The transparency of the metasurface preserves the windows' aesthetic appeal and allows natural light to enter, maintaining a bright, open environment. The technology described herein allows for low profile and aesthetically pleasing solutions to wireless connectivity issues in home or office spaces.

Transparent displays with beamforming capabilities are also facilitated; for example, transparent displays used for digital signage in retail settings can incorporate optically transparent reflective metasurfaces to function as beamforming devices. This enables them to direct mm-wave signals to specific areas, enhancing wireless connectivity for customers while remaining invisible and ensuring the display content is unaffected. Transparent metasurfaces can be applied to displays, increasing the mm-Wave wireless coverage within an environment without compromising the visibility of the display. This allows mm-Wave beam-steering metasurfaces to be integrated into the environment while maintaining a low profile. It also allows the metasurface to be combined with existing objects within the environment, reducing the space required to deploy these devices.

Urban infrastructure enhancements are feasible; reconfigurable reflectarrays can be deployed in urban environments to intelligently improve wireless coverage. Because beam-steering in a graphene-based metasurface can be altered through electronic biasing, these reflectarrays can be dynamically reprogrammed to adapt to obstacles within the environment. For example, in urban areas, reflective metasurfaces/reflectarrays can be added to bus shelters, light poles, or streetlamps to improve wireless signal coverage in areas with poor reception, such as narrow streets or congested zones. Such metasurfaces enhance connectivity without obstructing visibility or altering the infrastructure's appearance.

Advanced automotive applications can leverage transparent reflective metasurfaces. For example, transparent reflectarrays can be mounted on transparent panoramic roofs in vehicles, enhancing connectivity within the vehicle without compromising transparency. Including reconfigurable elements such as graphene within the reflectarray could also allow for adaptive beam steering as the vehicle moves with respect to the wireless transmitter. Reflectarrays embedded in panoramic vehicle roofs can redirect mm-wave signals within the vehicle, providing reliable connectivity for the passengers even in weak signal areas. The transparency of the metasurface maintains the roof's design and unobstructed views.

Intelligent reconfigurable beam-steering is also provided, as including reconfigurable elements in the reflectarrays allows reprogrammable beam steering to adapt to a changing wireless environment. This can be used to maintain sufficient connectivity between wireless receiver and transmitter links by tracking the movement of wireless devices in the environment and intelligently reprogramming the beam steering direction to follow the wireless device.

What has been described above include mere examples. It is, of course, not possible to describe every conceivable combination of components, materials or the like for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A unit cell device, comprising:
a resonating element, comprising a split metallic ring set and a amplitude control device set coupled to a gap set in the split metallic ring, the amplitude control device set comprising a graphene material patch set that changes resistance based on applied voltage; and
at least a portion of a ground plane beneath the metallic resonating element and the amplitude control device,
wherein the resistance of the graphene material patch set is controllably variable, when varied, to result in a corresponding reflection amplitude of the unit cell.

2. The unit cell device of claim 1, wherein, when the resistance of the graphene material patch set is controllably varied, a corresponding phase response results in the unit cell being varied based on the resistance.

3. The unit cell device of claim 1, further comprising:
an optically transparent, or substantially optically transparent, substrate between the metallic resonating element and the mesh ground plane.

4. The unit cell device of claim 1, wherein the split metallic ring set and the amplitude control device set comprise a hexagonal resonator.

5. The unit cell device of claim 1, wherein the split metallic ring set comprises a first metallic part and a second metallic part separated by a first gap and a second gap, respectively, of the gap set, wherein the amplitude control device set comprises a first graphene material patch that couples the first metallic part to the second metallic part at the first gap, and wherein the amplitude control device set comprises a second graphene material patch that couples the first metallic part to the second metallic part at the second gap.

6. The unit cell device of claim 5, wherein the split metallic ring set and the amplitude control device set comprise a hexagonal resonator, wherein the first gap and the first graphene material patch are on a first side of the hexagonal resonator, and wherein the second gap and the second graphene material patch are on a second side of the hexagonal resonator that is different from the first side.

7. The unit cell device of claim 6, wherein the first side is opposite the second side.

8. The unit cell device of claim 1, wherein the substrate is an optically transparent, or substantially optically transparent, substrate, wherein the ground plane is a substantially optically transparent mesh ground plane, and wherein the split metallic ring set, the graphene material patch set, and at least the portion of the mesh ground plane form a substantially optically transparent unit cell.

9. The unit cell device of claim 8, wherein the substantially optically transparent unit cell is part of a honeycomb lattice of unit cell devices.

10. The unit cell device of claim 8, wherein the substantially optically transparent unit cell is part of a metasurface of unit cells.

11. The unit cell device of claim 1, wherein the resistance of the graphene material comprises a sheet resistance, wherein the resistance of the graphene material patch set is controllably varied by controllably varying controllably variable resistance values, wherein, in a first regime, the controllably variable resistance values of the graphene material correspond to a decrease in reflection amplitude as the sheet resistance increases, wherein, in a second regime, the controllably variable resistance values of the graphene material correspond to an increase in reflection amplitude as the sheet resistance increases, and wherein the sheet resistance, in the first regime, comprises a first range of low sheet resistance values lower than, and relative to, a second range of high sheet resistance values in the second regime.

12. The device of claim 1, wherein the unit cell is a first unit cell of respective unit cells configured as a metasurface, wherein the respective unit cells have respective controllably variable reflection amplitudes and respective controllably variable phase responses, and wherein the respective variable reflection amplitudes and the respective variable phase responses are controlled to result in a phase profile of the metasurface that redirects a signal impinging on the metasurface as a redirected beamformed instance of the signal.

13. A metasurface, comprising:
a substrate;
respective unit cells above the substrate, the respective unit cells comprising respective resonators having respective variable phases, the respective resonators comprising respective metal ring sets and respective voltage-controllable graphene material patch sets; and
a mesh ground plane beneath the substrate, the mesh ground plane comprising openings that are optically transparent or substantially optically transparent,
wherein the metasurface is a substantially optically transparent metasurface based on the substrate being transparent or substantially optically transparent, the mesh ground plane being transparent or substantially optically transparent, and respective dimensions of the respective resonators.

14. The metasurface of claim 13, wherein the respective voltage-controlled graphene material patch sets are independently controlled to determine an amplitude and phase profile that redirects a signal impinging on the metasurface as a redirected beamformed instance of the signal.

15. The metasurface of claim 14, wherein the respective voltage-controlled graphene material patch sets are independently controlled in a first operation to determine a first amplitude and phase profile, wherein the signal impinging on the metasurface is a first signal, wherein the redirected beamformed instance is a first redirected beamformed instance, wherein the first redirected beamformed instance of the signal has a first amplitude value and a first direction, wherein the respective voltage-controlled graphene material patch sets are independently controlled in a second operation to determine a second amplitude and phase profile that redirects a second signal impinging on the metasurface as a second redirected beamformed instance of the signal, and wherein the second redirected beamformed instance of the signal has a second amplitude value and a second direction that is different from the first amplitude value and the first direction.

16. The metasurface of claim 13, wherein the respective unit cells are arranged in a honeycomb lattice configuration.

17. The metasurface of claim 13, wherein the respective resonators comprise substantially optically transparent respective metal ring sets and respective voltage-controllable graphene material patch sets, wherein the substrate is an optically transparent, or substantially optically transparent, substrate, wherein the ground plane is a substantially optically transparent mesh ground plane, and wherein the respective resonators, the optically transparent, or substantially optically transparent, substrate, and the substantially optically transparent mesh ground plane sets form the metasurface as a substantially optically transparent metasurface.

18. A unit cell, comprising:
a resonating element, the resonating element comprising a ring resonator comprising at least two metallic parts divided by, and coupled to, at least one graphene patch set having variable resistance;
an optically transparent, or substantially optically transparent, substrate beneath the resonating element; and
a metal mesh structure corresponding to a ground plane beneath the optically transparent, or substantially optically transparent, substrate, the metal mesh structure comprising optically transparent openings,
wherein, in response to an electromagnetic wave impinging on the unit cell at a frequency that resonates the resonating element, the unit cell redirects an instance of the electromagnetic wave based on a reflection amplitude and phase response determined by the variable resistance of the at least one graphene patch set.

19. The unit cell of claim 18, wherein the at least two metallic parts, in conjunction with the at least one graphene patch set, comprise a hexagonally-shaped ring resonator.

20. The unit cell of claim 18, wherein the at least two metallic parts comprise a first metallic part and a second metallic part separated by a first gap and a second gap, respectively, wherein the at least one graphene patch set comprises a first graphene material patch that couples the first metallic part to the second metallic part at the first gap, and wherein the at least one graphene patch set comprises a second graphene material patch that couples the first part to the second part at the second gap.
